(19) United States
(12) Patent Application Publication
(10) Pub. No.: US 2006/0282633 A1
(43) Pub. Date: Dec. 14, 2006

(54) Information processing apparatus and control method of the same

(75) Inventor: Takashi Iwai, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/401,191

(22) Filed: Apr. 10, 2006

(30) Foreign Application Priority Data
May 24, 2005 (JP) P2005-151039

(51) Int. Cl. G06F 12/00

(52) U.S. Cl. 711/163

(57) ABSTRACT

According to one embodiment, an information processing apparatus includes: a body; a receiving part disposed in the body and detachably receiving a magnetic disk drive device; a lock mechanism locking the magnetic disk drive device received in the receiving part and releasing lock in response to an electrical signal; an authentication section performing authentication processing for determining whether or not a user who requests release of the lock is an authorized user; and a control section powering off the magnetic disk drive device received in the receiving part and supplying the electrical signal to the lock mechanism in order to release the lock when the authentication section determines that the user is the authorized user.

### CROSS-REFERENCE TO RELATED APPLICATIONS

This application is based upon and claims the benefit of priority from Japanese Patent Application No. 2005-151039, filed May 24, 2005, the entire contents of which are incorporated herein by reference.

### BACKGROUND

1. Field

One embodiment of the invention relates to an information processing apparatus such as a personal computer and a control method for controlling the information processing apparatus.

2. Description of the Related Art

Computers having various security functions have been developed in recent years. For example, in JP-A-2000-194448, a technique for inhibiting insertion and detachment of a medium with respect to a CD-ROM drive or a flexible disk drive is disclosed.

A computer disclosed in JP-A-2000-194448 includes a file bay cover with an electronic lock. This file bay cover is attached to the front of a casing, and is used for covering the CD-ROM drive or the flexible disk drive received in the casing. Both of locking and unlocking of the file bay cover are performed by actuating a solenoid. In a state in which the file bay cover is closed and the file bay cover is locked, insertion and detachment of a medium with respect to the CD-ROM drive or the flexible disk drive are inhibited.

By the way, a large volumetric magnetic disk drive (hard disk drive) has been developed recently, and work of replacement, etc., of the magnetic disk drive mounted in a computer is done as necessary.

However, in a personal computer of a portable type such as a notebook type or a laptop type, a magnetic disk drive (hard disk drive) is previously built into a body of the computer, so that work of replacement, etc., of its magnetic disk drive is relatively difficult.

As a result of this, achievement of a mechanism for detachably attaching the magnetic disk drive to the body has been desired also in the portable personal computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an outward appearance of a computer of according to one embodiment of the invention;

FIG. 2 is an exemplary diagram showing a receiving part for detachably receiving an HDD to the computer of FIG. 1;

FIG. 3 is an exemplary block diagram showing a system configuration of the computer of FIG. 1;

FIG. 4 is an exemplary diagram showing an example of a configuration of a driving circuit used in the computer of FIG. 1;

FIG. 5 is an exemplary diagram showing an example of a configuration of a lock mechanism disposed in the computer of FIG. 1;

FIG. 6 is an exemplary diagram showing a situation in which the lock mechanism of FIG. 5 is set in an unlocked position;

FIG. 7 is an exemplary diagram showing a flow of a signal at the time of unlocking in the computer of FIG. 1;

FIG. 8 is an exemplary flowchart showing a procedure of processing performed by a BIOS in the computer of FIG. 1;

FIG. 9 is an exemplary flowchart showing a procedure of processing performed by an operating system in the computer of FIG. 1; and

FIG. 10 is an exemplary diagram showing an example of another configuration of a lock mechanism disposed in the computer of FIG. 1.

### DETAILED DESCRIPTION

Various embodiments according to the invention will be described below in detail with reference to the drawings. In general, according to one embodiment of the invention, an information processing apparatus includes: a body; a receiving part disposed in the body and detachably receiving a magnetic disk drive device; a lock mechanism locking the magnetic disk drive device received in the receiving part and releasing lock in response to an electrical signal; an authentication section performing authentication processing for determining whether or not a user who requests release of the lock is an authorized user; and a control section powering off the magnetic disk drive device received in the receiving part and supplying the electrical signal to the lock mechanism in order to release the lock when the authentication section determines that the user is the authorized user.

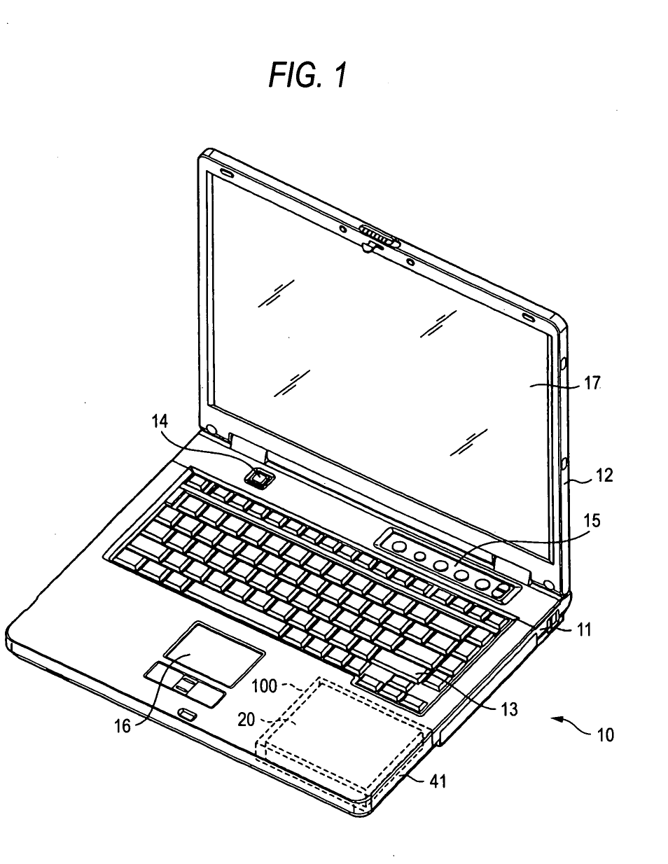

Referring first to FIGS. 1 to 3, a configuration of an information processing apparatus according to one embodiment of the invention will be described. This information processing apparatus is implemented as, for example, a notebook type portable personal computer 10.

FIG. 1 is an exemplary perspective view in a state of opening a display unit of the personal computer 10. The computer 10 includes a body 11 and a display unit 12. A display including an LCD (Liquid Crystal Display) 17 is incorporated into the display unit 12, and a display screen of its LCD 17 is located in approximately the center of the display unit 12.

The display unit 12 is rotatably mounted between an opened position in which the upper surface of the body 11 is exposed and a closed position in which the upper surface of the body 11 is covered with respect to the body 11. The body 11 has a casing with a thin box shape, and a keyboard 13, a power button 14 for turning on and off a power source of the computer 10, an input operation panel 15 and a touch pad 16, etc., are arranged on the upper surface of the body 11.

The input operation panel 15 is an input device for inputting an event corresponding to a pressed button switch, and includes plural button switches for respectively activating plural functions. A group of these button switches include a button switch for activating a particular application program.

The body 11 is provided with a receiving part 100 for detachably receiving a magnetic disk drive device (HDD: hard disk drive) 20. This receiving part 100 is formed of a recess disposed in the casing of the body 11. An example of disposing the recess in a right side wall of the body 11 is shown in FIG. 1. Of course, the recess may be disposed in a bottom wall of the body 11. An HDD lid 41 can be attached to the right side wall of the body 11. The HDD lid 41 is a lid member for blocking the recess forming the receiving part 100. In a state in which the HDD lid 41 is closed, that is, the HDD lid 41 is attached to the body 11, the recess is blocked and the right side wall of the body 11 becomes approximately flat.

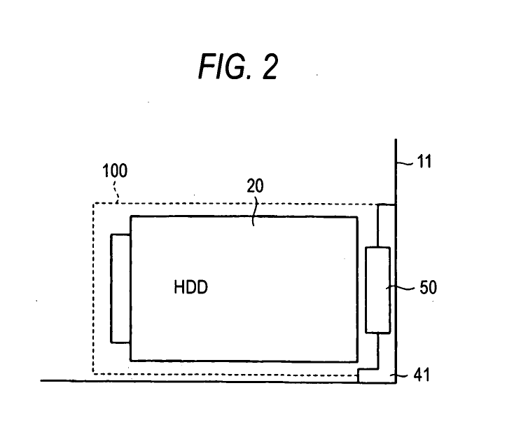

The receiving part 100 is provided with a lock mechanism 50 as shown in FIG. 2. This lock mechanism 50 is a mechanism for locking the HDD 20 received inside the receiving part 100 in a received position of the inside of the receiving part 100 and preventing detachment of the HDD 20. This lock mechanism 50 is constructed of, for example, a mechanism for locking the HDD lid 41 to the body 11 and preventing detachment of the HDD lid 41. When the HDD lid 41 is closed, the HDD lid 41 is automatically locked to the body 11 by the lock mechanism 50 and the HDD lid 41 cannot be detached from the body 11. The lock mechanism 50 includes a solenoid and the HDD lid 41 is unlocked in response to an electrical signal.

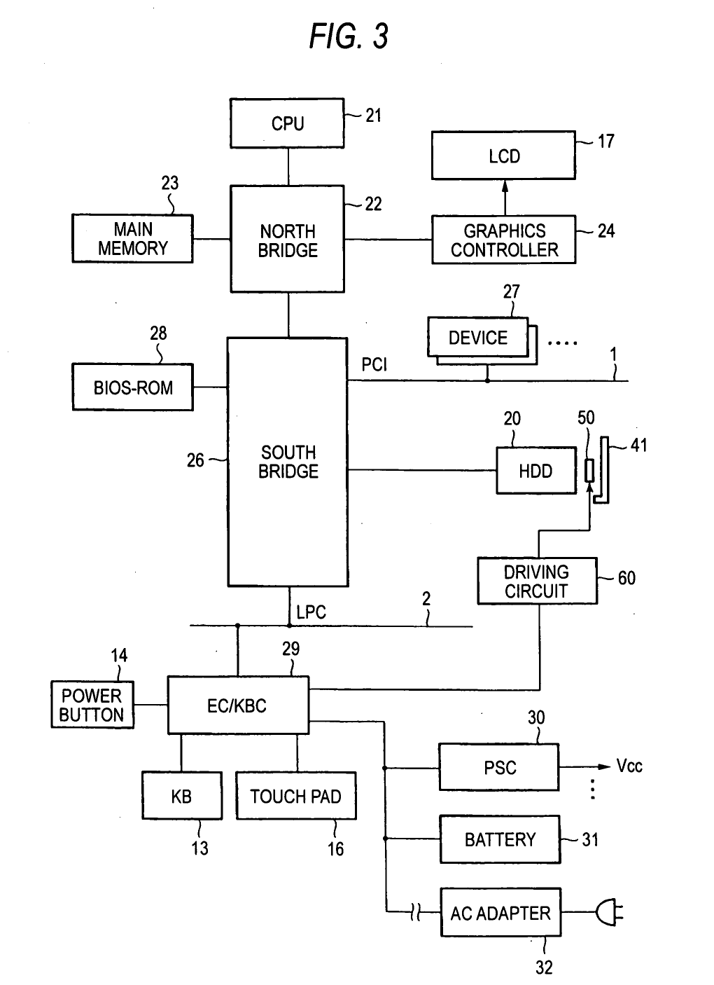

FIG. 3 shows a system configuration of the computer 10.

The computer 10 includes a battery 31, and operates by electric power from the battery 31 in a state in which the computer 10 is not connected to an external power source (AC power source). On the other hand, in a state in which an AC adapter 32 is connected to the computer 10, that is, the computer 10 is connected to the external power source (AC power source), the computer operates by the external power source (AC power source). Also, the battery 31 is charged by the external power source.

The computer 10 includes a CPU (Central Processing Unit) 21, a north bridge 22, main memory 23, a graphics controller 24, a south bridge 26, a PCI (Peripheral Component Interconnect) device group 27, BIOS-ROM 28, an embedded controller/keyboard controller IC (EC/KBC) 29, and a power source controller (PSC) 30, etc.

The CPU 21 is a processor for controlling an action of the computer, and executes various programs (an operating system, an application program) loaded from the HDD 20 to the main memory 23. Also, the CPU 21 executes a BIOS (Basic Input Output System) stored in the BIOS-ROM 28. The BIOS is a program for controlling hardware. Also, the BIOS performs processing for controlling the lock mechanism 50 and unlocking the HDD 20. In this case, before the unlocking, the BIOS performs processing for authenticating a user who requests the unlocking. Only in the case of checking that the user who requests the unlocking is an authorized user (an administrator or a registered user of the computer), the BIOS sends an electrical signal to the lock mechanism 50 through the EC/KBC 29 and sets the lock mechanism 50 in an unlocked state. As a result of this, the user can detach the HDD 20 and perform replacement, etc., of the HDD.

The north bridge 22 is a bridge device for making connection between the south bridge 26 and a local bus of the CPU 21. A memory controller for controlling the main memory 23 is also built into this north bridge 22. The graphics controller 24 is a display controller for controlling the LCD 17 used as a display monitor of the computer. The south bridge 26 communicates with the PCI device group 27 through a PCI bus 1. A disk controller for controlling the HDD 20 is also built into this south bridge 26. Also, the south bridge 26 performs control of each of the devices on an LPC (Low Pin Count) bus 2.

The embedded controller/keyboard controller IC (EC/KBC) 29 is a one-chip microcomputer into which an embedded controller for power management and a keyboard controller for controlling the keyboard (KB) 13 and the touch pad 16 are integrated. This embedded controller/keyboard controller IC (EC/KBC) 29 has a function of powering on and off the computer 10 in cooperation with the power source controller (PSC) 30 according to an operation of the power button 14 by a user. Further, the embedded controller/keyboard controller IC (EC/KBC) 29 has a function of setting the lock mechanism 50 in an unlocked state by controlling a driving circuit 60 under control of the BIOS. The driving circuit 60 is a circuit for driving a solenoid disposed in the lock mechanism 50, and passes a current through the solenoid when a control signal is inputted from the EC/KBC 29.

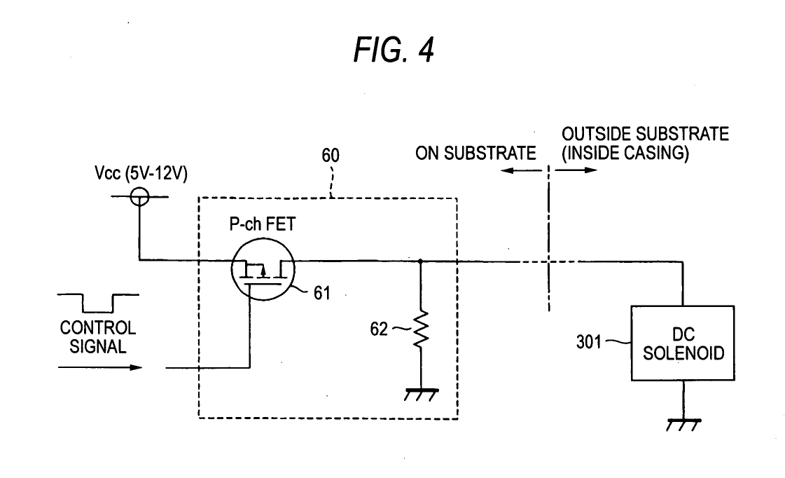

An example of the driving circuit 60 is shown in FIG. 4.

The driving circuit 60 includes a P-channel power MOSFET 61 and a resistor 62 as shown in FIG. 4. A source of the FET 61 is connected to a power source terminal and also a drain of the FET 61 is connected to a solenoid (DC solenoid) 301 of the inside of the lock mechanism 50.

When a control signal inputted from the EC/KBC 29 is at a High level, the FET 61 is turned off and a current does not flow through the DC solenoid 301. When the control signal is at a Low level, the FET 61 is turned on and thereby, a current flows through the DC solenoid 301 and the DC solenoid 301 is excited. The lock mechanism 50 shifts to an unlocked state by exciting the DC solenoid 301.

In the embodiment, the DC solenoid 301 could be operated only at the moment of the unlocking. As a result of this, the EC/KBC 29 could output a Low pulse once as a control signal. A power source voltage VCC supplied to the power source terminal is the same power source voltage as a main power source voltage of the computer 10. As a result of this, only when the computer 10 is powered on and a control signal is supplied to the driving circuit 60, the lock of the HDD 20 by the lock mechanism 50 is released.

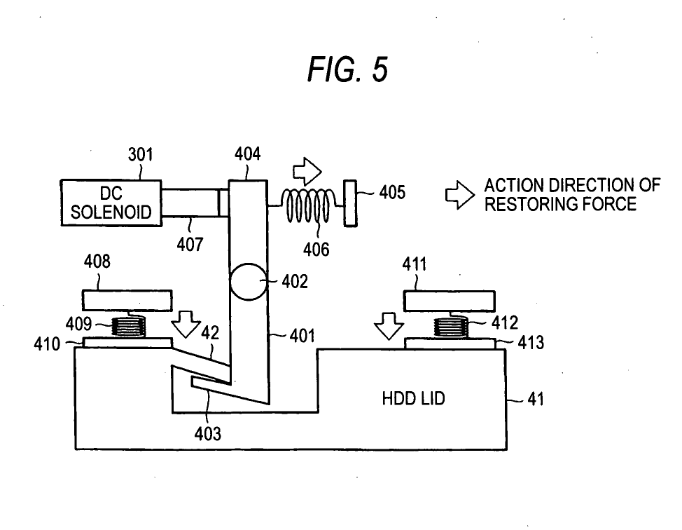

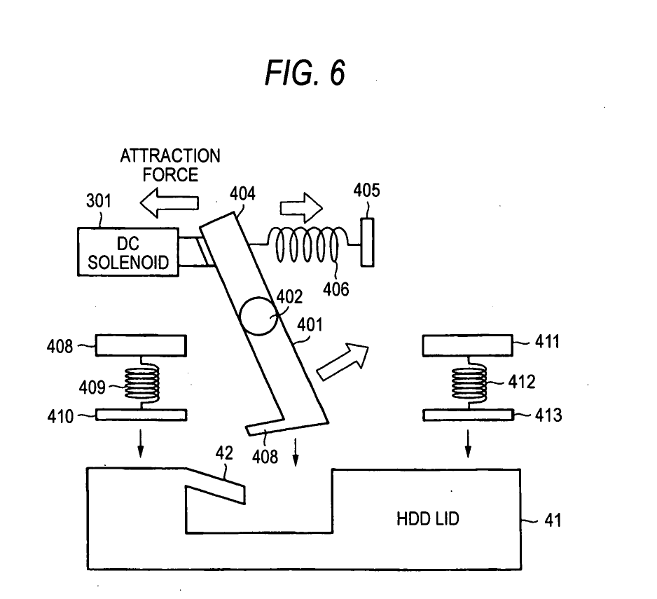

Next, a configuration example of the lock mechanism 50 will be described with reference to FIGS. 5 and 6.

The lock mechanism 50 includes the DC solenoid 301, an arm 401, fixed plates 405, 408, 411, springs 406, 409, 412, an actuator 407, and support plates 410, 413. The fixed plates 405, 408, 411 are fixed in predetermined positions of the body 11, respectively.

The arm 401 is a lock member for locking the HDD lid 41 to the body 11. The arm 401 is disposed movably between a locked position in which the HDD lid 41 is locked to the body 11 and an unlocked position in which the HDD lid 41 is unlocked. The DC solenoid 301 and the actuator 407 are a lock member driving mechanism for driving the arm 401, and moves the arm 401 from the locked position to the unlocked position when a control signal is inputted from the EC/KBC 29.

An engagement stop pawl 403 for engaging and stopping an engagement protrusion 42 disposed on the HDD lid 41 is disposed on one end of the arm 401. The center of the arm 401 is rotatably supported by a rotating shaft 402. The right side of the other end 404 of the arm 401 is connected to the fixed plate 405 through the spring 406 and also the left side of the other end 404 of the arm 401 is connected to the actuator 407. In a normal state in which the DC solenoid 301 does not operate, the arm 401 is set in the locked position by force of the spring 406 (FIG. 5).

An action of the lock mechanism 50 at the time of closing the HDD lid 41 will be described herein.

Since the engagement protrusion 42 and the engagement stop pawl 403 respectively have inclined surfaces, when the HDD lid 41 is pushed in a state in which a surface of the engagement protrusion 42 of the HDD lid 41 is abutted on the engagement stop pawl 403, the arm 401 slightly slides in a counterclockwise direction and thereby the engagement protrusion 42 enters the side of an inner surface of the engagement stop pawl 403. Thereafter, the arm 401 is returned to the locked position by force of the spring 406 and the engagement protrusion 42 becomes a state (a locked state of FIG. 5) engaged and stopped by the engagement stop pawl 403. In this locked state, the HDD lid 41 cannot be detached. Since the HDD lid 41 is mechanically locked, the HDD lid 41 is not unlocked even if the battery 31 is detached.

Next, an action of the lock mechanism 50 at the time of the unlocking will be described.

When the DC solenoid 301 is excited and attraction force acts, force exceeding restoring force of the spring 406 is applied to the arm 401 and the arm 401 slides in a counterclockwise direction and moves to the unlocked position (FIG. 6). As a result of this, the lock is released and the HDD lid 41 is automatically detached by restoring force of the springs 409, 412.

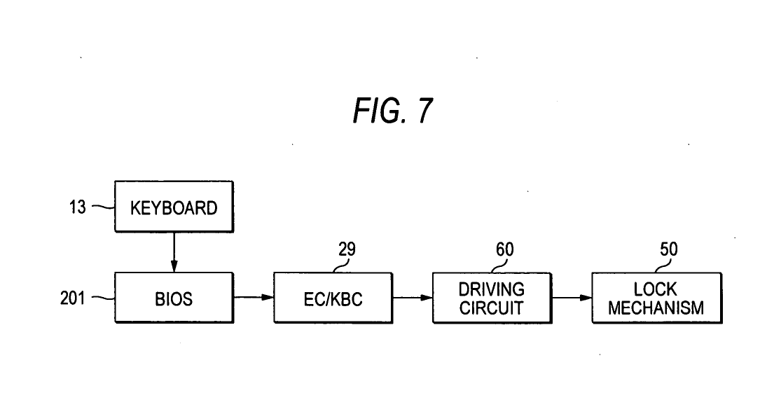

Next, a flow of a signal at the time of the unlocking will be described with reference to FIG. 7.

Unlocking processing is performed in a state in which the computer 10 is powered on. When an event for requesting the unlocking is inputted by an operation of the keyboard 13, etc., by a user, a BIOS 201 determines whether or not the user who requests the unlocking is an authorized user. When the user is the authorized user, the BIOS 201 sends an unlocking command to the EC/KBC 29. The EC/KBC 29 sends a control signal to the driving circuit 60 and thereby, the DC solenoid 301 of the lock mechanism 50 operates.

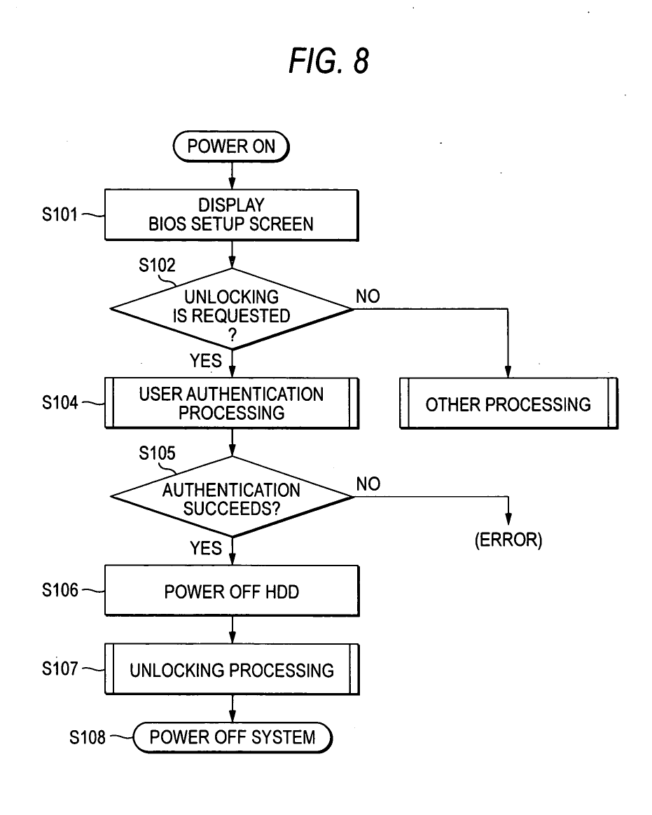

Next, processing performed by the BIOS will be described with reference to a flowchart of FIG. 8.

When the computer 10 is powered on in a state of pressing a particular key, the BIOS displays a BIOS setup screen on the LCD 17. The BIOS setup screen is a screen for setting an operating environment of the computer 10. An item of “HDD unlocking” is also displayed on this BIOS setup screen. When the item of “HDD unlocking” on the BIOS setup screen is selected by an operation of the keyboard 13 by a user, that is, the HDD unlocking is requested by the user (YES of step S102), the BIOS performs user authentication processing (step S104).

In step S104, the BIOS prompts the user to input a password by displaying a password input screen on the LCD 17. When the password is inputted by an operation of the keyboard 13 by the user, the BIOS compares the inputted password with a password (a password of an authorized user) already stored in the BIOS-ROM 28, and determines whether or not the user who requests the HDD unlocking is the authorized user according to its comparison result.

In the case of checking that the user is the authorized user (YES of step S105), the BIOS powers off the HDD 20 by stopping power source supply to the HDD 20 by controlling the EC/KBC 29 (step S106). Thereafter, the BIOS sends an unlocking command to the EC/KBC 29 in order to unlock the HDD 20 (step S107). The EC/KBC 29 sends a control signal to the driving circuit 60 and thereby, the DC solenoid 301 of the lock mechanism 50 operates and the HDD lid 41 is automatically detached. At this point in time, the HDD 20 has already been powered off, so that the user can safely detach the HDD 20. At a point in time when a certain period has elapsed since the unlocking command was sent to the EC/KBC 29, the BIOS sends a power-off command to the EC/KBC 29 and powers off the computer 10 (step S108).

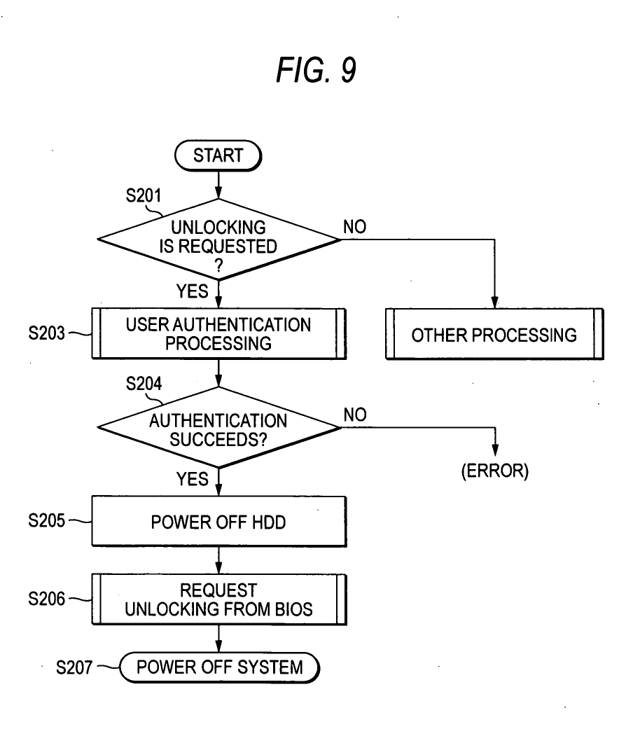

Incidentally, the user can also use a hardware setup screen offered by an operating system and request unlocking by an operation on its hardware setup screen. A processing procedure of this case is shown in FIG. 9.

An item of “HDD unlocking” is displayed on the hardware setup screen. When the item of “HDD unlocking” on the hardware setup screen is selected by an operation of the keyboard 13 by a user, that is, the HDD unlocking is requested by the user (YES of step S201), the operating system performs user authentication processing (step S203).

In step S203, the operating system prompts the user to input a password by displaying a password input screen on the LCD 17. When the password is inputted by an operation of the keyboard 13 by the user, the operating system compares the inputted password with a password (for example, an administrator password) already stored in the HDD 20, and determines whether or not the user who requests the HDD unlocking is an authorized user (administrator) according to its comparison result.

In the case of checking that the user is the authorized user (YES of step S204), the operating system powers off the HDD 20 by stopping power source supply to the HDD 20 by controlling the EC/KBC 29 through the BIOS or by controlling the EC/KBC 29 directly (step S205). In this step S205, the operating system first stops execution of software (an HDD driver program, etc.) for accessing the HDD 20 and thereafter powers off the HDD 20.

Thereafter, the operating system requests unlocking of the HDD from the BIOS (step S206). The BIOS sends an unlocking command to the EC/KBC 29 in order to unlock the HDD 20. The EC/KBC 29 sends a control signal to the driving circuit 60 and thereby, the DC solenoid 301 of the lock mechanism 50 operates and the HDD lid 41 is automatically detached. At this point in time, the HDD 20 has already been powered off, so that the user can safely detach the HDD 20. At a point in time when a certain period has elapsed since the unlocking command was sent to the EC/KBC 29, the BIOS sends a power-off command to the EC/KBC 29 and powers off the computer 10 (step S207).

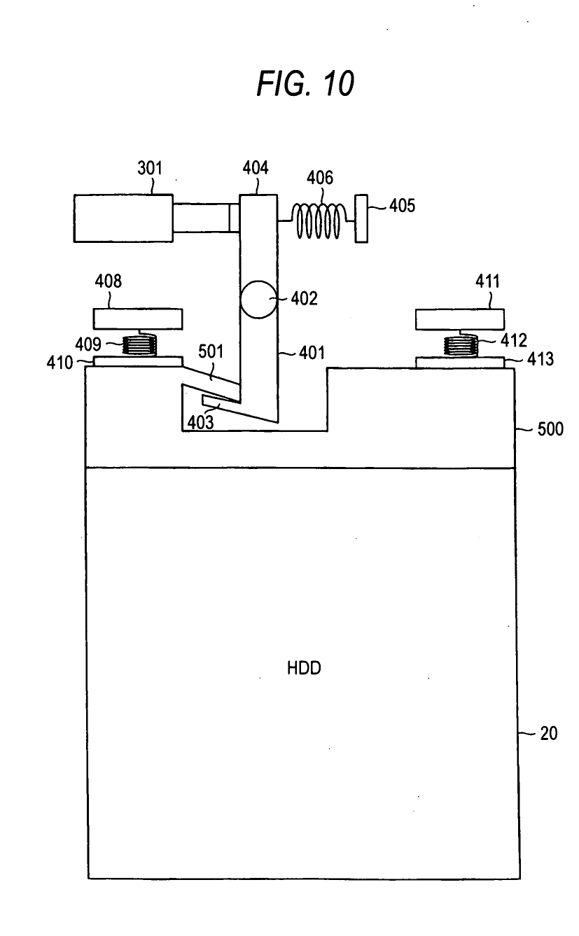

Incidentally, in the above description, the case of locking the HDD lid 41 has been illustrated, but the HDD 20 itself may be locked inside the receiving part 100. In this case, for example, an HDD 20 is provided with an engagement part 500 having an engagement protrusion 501 as shown in FIG. 10. A configuration of a lock mechanism 50 may be the same as the configuration shown in FIGS. 5 and 6.

When the HDD 20 is received in a receiving part 100, the engagement protrusion 501 is engaged and stopped in an engagement stop pawl 403 and thereby the HDD 20 is locked inside the receiving part 100. When a DC solenoid 301 is excited, an arm 401 slides in a counterclockwise direction and moves to an unlocked position. Then, the HDD 20 is slightly pushed out toward the outside by force of springs 409, 412 and thereby the HDD 20 is unlocked.

Incidentally, it may be constructed so that a sensor for detecting that the HDD 20 is detached is disposed in the receiving part 100 and the DC solenoid 301 continues to be driven until the sensor detects that the HDD 20 is actually detached. In this case, fixed plates 408, 411, springs 409, 412 and support plates 410, 413 are not necessarily required. In the case of detecting that the HDD 20 is detached, a BIOS stops driving of the DC solenoid 301.

As described above, in the embodiment, the HDD is unlocked only in the case of checking that the user who requests the unlocking is an authorized user. Therefore, the HDD can be prevented from being stolen. Also, the HDD is unlocked after the HDD is powered off, so that a danger that the HDD is detached in a power-on state is eliminated, and the HDD can be detached safely. Also, since the HDD is mechanically locked, the HDD cannot be detached even if the battery 31 is detached from the computer 10.

Incidentally, in a system having a biometric function of a fingerprint sensor, etc., authentication processing may be performed using the fingerprint sensor instead of a password input.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An information processing apparatus comprising:
a body;
a receiving part disposed in the body and detachably receiving a magnetic disk drive device;
a lock mechanism locking the magnetic disk drive device received in the receiving part and releasing lock in response to an electrical signal;
an authentication section performing authentication processing for determining whether or not a user who requests release of the lock is an authorized user; and
a control section powering off the magnetic disk drive device received in the receiving part and supplying the electrical signal to the lock mechanism in order to release the lock when the authentication section determines that the user is the authorized user.

2. The information processing apparatus as claimed in claim 1, wherein the receiving part includes a recess disposed in the body, and the lock mechanism includes a lid member for blocking the recess, the lid member being locked to the body and unlocked in response to the electrical signal.

3. The information processing apparatus as claimed in claim 1, wherein the receiving part includes a recess disposed in the body, and the lock mechanism includes a lock member disposed movably between a locked position in which a lid member for blocking the recess is locked to the body and an unlocked position in which the lid member is unlocked and is set in the locked position in response to the fact that the lid member is attached to the body, and a lock member driving mechanism for moving the lock member from the locked position to the unlocked position by the electrical signal.

4. The information processing apparatus as claimed in claim 1, wherein the lock mechanism includes a lock member disposed movably between a locked position in which the magnetic disk drive device is locked to the receiving part and an unlocked position in which the magnetic disk drive device is unlocked and is set in the locked position in response to the fact that the magnetic disk drive device is received in the receiving part, and a lock member driving mechanism for moving the lock member from the locked position to the unlocked position by the electrical signal.

5. The information processing apparatus as claimed in claim 1, wherein the authentication section includes a storage part storing a password, and a comparing section comparing the password stored in the storage part with a password inputted by an operation of an input device disposed in the information processing apparatus and determining whether or not the user who requests the release of the lock mechanism is the authorized user.

6. The information processing apparatus as claimed in claim 1, wherein the authentication section performs the authentication processing when an event for requesting the release of the lock mechanism is inputted by an operation of an input device disposed in the information processing apparatus.

7. A control method for controlling an information processing apparatus including a body having a receiving part detachably receiving a magnetic disk drive device, and a lock mechanism locking the magnetic disk drive device to the receiving part and releasing lock in response to an electrical signal, the method comprising the steps of:
performing authentication processing for determining whether or not a user who requests release of the lock is an authorized user; and
powering off the magnetic disk drive device received in the receiving part and supplying the electrical signal to the lock mechanism to release the lock when the authentication processing determines that the user is the authorized user.

8. The control method as claimed in claim 7, wherein the lock mechanism includes a lock member disposed movably between a locked position in which the magnetic disk drive device is locked to the receiving part and an unlocked position in which the magnetic disk drive device is unlocked and is set in the locked position in response to the fact that the magnetic disk drive device is received in the receiving part, and a lock member driving mechanism for moving the lock member from the locked position to the unlocked position by the electrical signal.

9. The control method as claimed in claim 7, wherein the authentication processing includes a step of comparing a password inputted by an operation of an input device disposed in the information processing apparatus with a password stored in a storage part disposed in the information processing apparatus and determining whether or not the user who requests the release of the lock mechanism is the authorized user.

10. The control method as claimed in claim 7, wherein the step of performing the authentication processing performs the authentication processing when an event for requesting the release of the lock mechanism is inputted by an operation of an input device disposed in the information processing apparatus.
